(19) United States
(12) Patent Application Publication
(10) Pub. No.: US 2012/0169146 A1
(43) Pub. Date: Jul. 5, 2012

(54) LINEAR VIBRATION MOTOR

(75) Inventor: Joon Choi, Gynggi-do (KR)

(73) Assignee: SAMSUNG ELECTRO-MECHANICS CO., LTD., Gyunggi-do (KR)

(21) Appl. No.: 13/339,006

(22) Filed: Dec. 28, 2011

(30) Foreign Application Priority Data
Dec. 30, 2010 (KR) 1020100139340

(51) Int. Cl. H02K 33/00

(52) U.S. Cl. 310/15

(57) ABSTRACT

Disclosed herein is a linear vibration motor. A stator includes a coil which forms a magnetic field using an external power applied thereto. A vibrator includes a magnet which faces the coil, and a yoke which has a coupling part. The magnet is coupled to the coupling part. An elastic member has a first end coupled to the stator, and a second end coupled to the yoke. The elastic member elastically supports linear vibration motion of the vibrator. The coupling part has a plurality of openings therein so that an electromagnetic force generated by electromagnetic induction of the magnet and the coil leaks out through the openings.

### CROSS REFERENCE TO RELATED APPLICATION

This application claims the benefit of Korean Patent Application No. 10-2010-0139340, filed Dec. 30, 2010, entitled “Linear vibration motor,” which is hereby incorporated by reference in its entirety into this application.

### BACKGROUND OF THE INVENTION

1. Technical Field

The present invention relates to a linear vibration motor.

2. Description of the Related Art

Generally, linear vibration motors convert electric energy into mechanical energy using the principle of generation of electromagnetic force. Such linear vibration motors are installed in electronic devices, such as mobile communication terminals, game players, etc., and are used to indicate signal reception in a mute mode or to generate vibration.

Recently, in accordance with the trend to provide small and slim mobile communication terminals, a linear vibration motor installed in such mobile communication terminals is also needed to be made small and slim, as well as to provide high performance.

As shown in FIG. 1, a conventional linear vibration motor includes a stator 10, a vibrator 20 which vibrates using electromagnetic interaction with the stator 10, and an elastic member 25 which elastically supports the stator 10 and the vibrator 20.

However, because internal elements constituting the stator 10 and the vibrator 20 are assembled in high-density arrays in the internal space of the linear vibration motor, the internal elements may interfere with each other even when only small external force is applied to the vibration motor.

Such interference between the internal elements causes noise which is counter to the purpose of the mute signal reception indication.

### SUMMARY OF THE INVENTION

The present invention has been made in an effort to provide a linear vibration motor which includes a yoke which has a plurality of openings with the same shape.

In a linear vibration motor according to an embodiment of the present invention, a stator includes a coil forming a magnetic field using an external power applied thereto. A vibrator includes a magnet and a yoke. The magnet faces the coil. The yoke has a coupling part. The magnet is coupled to the coupling part. The coupling part has a plurality of openings therein so that an electromagnetic force generated by electromagnetic induction of the magnet and the coil leaks out through the openings. An elastic member has a first end coupled to the stator, and a second end coupled to the yoke. The elastic member elastically supports linear vibration motion of the vibrator.

The openings may be formed through the coupling part by cutting off portions of the region of the coupling part that includes a junction between the magnet and the yoke.

Alternatively, the openings may be formed through the coupling part by cutting off portions of a region of the coupling part other than a junction between the magnet and the yoke.

The openings may comprise four openings formed through the coupling part. The four openings may have the same shape.

The magnet may be coupled to the coupling part of the yoke at a position facing the coil so that the magnet can be inserted into the coil when the magnet linearly vibrates.

The stator may include a bracket, a casing and a PCB. The bracket may have an upper surface to which the coil is fastened. The casing is coupled to the upper surface of the bracket. The casing may cover the bracket. The PCB may be provided between the bracket and the coil. The PCB may apply electric currents to the coil. The stator may further include a damper coupled to the bracket at a position facing the magnet.

The vibrator may include a weight, a plate yoke and a magnetic fluid. The weight may be coupled to an outer surface of the yoke. The plate yoke may be coupled to a lower end of the magnet. The magnetic fluid may be provided on a circumferential outer surface of the magnet.

The elastic member may comprise a plurality of magnetic fluids provided on a surface thereof facing the casing.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view of a linear vibration motor according to a conventional art;

FIG. 2 is a sectional view of a linear vibration motor, according to a first embodiment of the present invention;

FIG. 3 is an exploded perspective view of the linear vibration motor of FIG. 2;

FIG. 4 is a plan view of a vibrator shown in FIG. 2 according to the first embodiment of the present invention; and

FIG. 5 is a plan view of a vibrator of a linear vibration motor, according to a second embodiment of the present invention.

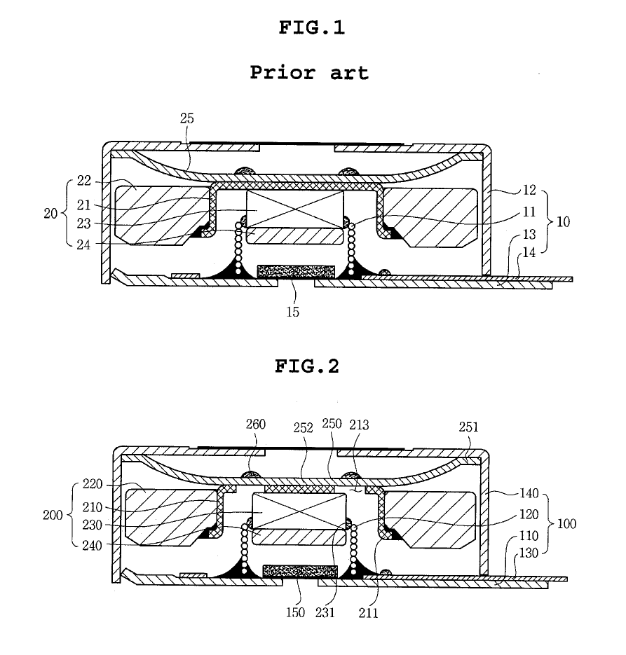

### DESCRIPTION OF THE PREFERRED EMBODIMENTS

Reference now should be made to the drawings, in which the same reference numerals are used throughout the different drawings to designate the same or similar components. In the following description, when it is determined that the detailed description of the conventional function and conventional structure would confuse the gist of the present invention, such a description may be omitted. Furthermore, it will be understood that although the terms “first”, “second” etc. may be used herein to describe various elements, these elements should not be limited by these terms. These terms are only used to distinguish one element from another element.

Hereinafter, embodiments of the present invention will be described in detail with reference to the attached drawings.

### First Embodiment

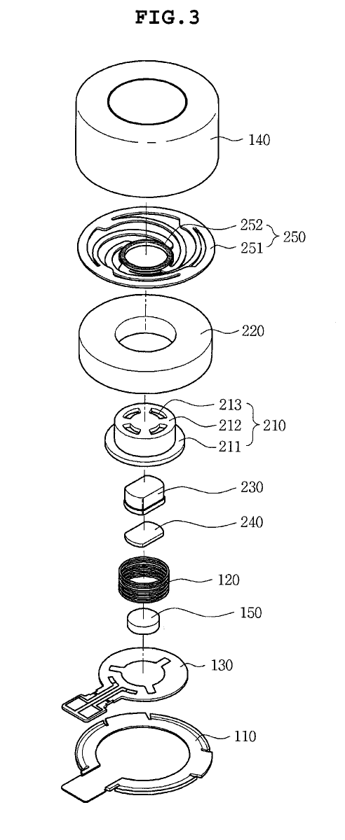

FIG. 2 is a sectional view of a linear vibration motor, according to a first embodiment of the present invention. FIG. 3 is an exploded perspective view of the linear vibration motor of FIG. 2.

As shown in the drawings, the linear vibration motor according to the present invention includes a stator 100, a vibrator 200 and an elastic member 250 which elastically supports the vibrator 200 that linearly vibrates.

The stator 100 includes a bracket 110, a coil 120, a PCB (printed circuit board) 130 and a casing 140. The vibrator 200 includes a yoke 210, a weight 220, a magnet 230 and a plate yoke 240.

In detail, the coil 120 is fastened to an upper surface of the bracket 110.

The PCB 130 is connected between the bracket 110 and the coil 120 so that electric currents are applied to the coil 120 from the PCB 130. In an embodiment of the present invention, an FPCB (flexible PCB) is used as the PCB 130.

Furthermore, the bracket 110 is made of non-magnetic material or low-magnetic material so as to prevent it from affecting the operation of the vibrator 200.

The casing 140 defines a space therein and is coupled to the upper surface of the bracket 110 to cover the bracket 110.

In addition, a damper 111 is provided on the bracket 110 at a position opposing to the magnet 230.

The damper 111 prevents the magnet 230 from coming into direct contact with the bracket 110 owing to excessive linear vibrations of the linear vibration motor, thus preventing the elements from being worn, and preventing noise from being generated from between the elements.

As shown in the drawings, the vibrator 200 includes the yoke 210, the weight 220, the magnet 230 and the plate yoke 240.

In detail, the yoke 210 includes a protrusion part 211 onto which the weight 220 is seated while the weight 220 is fitted over an outer surface of the yoke 210, and a coupling part 212 to which the magnet 230 is coupled, the magnet 230 generating electromagnetic force using electromagnetic interaction with the coil 120.

The weight 220 is fitted over the outer surface of the yoke 210 and seated onto the protrusion part 211 of the yoke 210. The weight 220 adds a predetermined amount of weight to the vibrator 200 to ensure a predetermined intensity of linear vibration motion of the linear vibration motor.

The magnet 230 is coupled to the lower surface of the coupling part 213 of the yoke 210 at a position opposing to the coil 120 provided on the upper surface of the bracket 110. The magnet 230 is configured such that it can be inserted into an internal space defined in the coil 120 while it linearly vibrates.

A magnetic fluid 231 is provided on a circumferential outer surface of the magnet 230. The plate yoke 240 is attached to a lower surface of the magnet 230.

The plate yoke 240 functions to induce the magnetic force of the magnet 230 to be regularly and smoothly formed.

As shown in FIG. 3, the elastic member 250 comprises a plate spring having a spiral structure to provide elastic force.

A first end 251 of the elastic member 250 is coupled to the casing 140, and a second end 252 thereof is coupled to an upper end of the yoke 210, so that the vibrator 200 that linearly vibrates is elastically supported by the elastic member 250.

In the elastic member 250 coupled to the vibrator 200, when a power-frequency is applied thereto, the maximum displacement occurs at a resonance point.

Furthermore, a magnetic fluid 260 is applied on a surface of the elastic member 250 which faces the casing 140.

Thus, the magnetic fluid 260 functions as a damper which prevents the elastic member 250 from coming into direct contact with the casing 140 when the vibrator 200 excessively linearly vibrates, thereby preventing these elements from being worn, and preventing noise from being generated by contact between the elements.

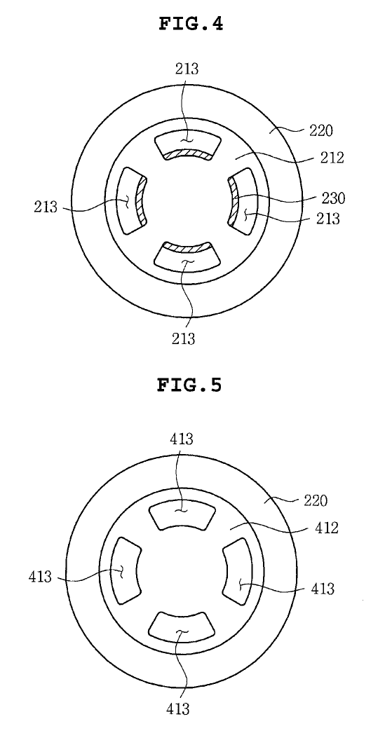

FIG. 4 is a plan view of the vibrator 200 shown in FIGS. 2 and 3 according to the first embodiment of the present invention. As shown in the drawing, the yoke 210 includes the coupling part 212 to which the magnet 230 is coupled, and the protrusion part 211 onto which the weight 200 is seated.

The coupling part 212 to which the magnet 230 has a plurality of openings 213 which have the same shape and through which electromagnetic force generated by electromagnetic interaction between the magnet 230 and the coil 120 leaks out.

In this embodiment, the four openings 213 having the same shape are formed through the coupling part 212.

The amount of electromagnetic force that leaks out is varied depending on the shape or diameter of the openings 213. As the size of each opening 213 increases, the amount of electromagnetic force that leaks out increases, but because the area with which the magnet 230 contacts the yoke 210 is reduced, the magnet 230 may be undesirably removed from the yoke 210 when the linear vibration motor excessively vibrates.

Therefore, in the first embodiment of the present invention, the openings 213 are formed by cutting both off portions of a region of the coupling part 212 corresponding to a junction between the magnet 230 and the coupling part 212 of the yoke 210 and off portions of a region of the coupling part 212 other than the junction between the magnet 230 and the coupling part 212.

In other words, each opening 213 includes space formed by cutting off a portion of the region with which the magnet 230 is coupled to the yoke 210.

Therefore, portions of the magnet 230 are exposed through the four openings 213 so that electromagnetic force can more easily leak out through the four openings 213 which are formed through the coupling part 212 and have the same shape.

Furthermore, because only portions of the region of the coupling part 213 corresponding to the junction between the magnet 230 and the yoke 210 are cut off, the magnet 230 can be reliably coupled to the yoke 210, thus preventing the magnet 230 from being removed from the yoke 210 by the linear vibration motion of the vibration 200.

As such, in the present invention, electromagnetic force generated by electromagnetic interaction between the magnet 230 and the coil 120 leaks out through the openings 213. Thus, to noise generated when the linear vibration motor linearly vibrates can be reduced.

Furthermore, the electromagnetic force that leaks out through the openings 213 reacts to the electromagnetic fluid 260 provided on the elastic member 250 and thus strengthens integration of the electromagnetic fluid 260, thereby enhancing the performance of the electromagnetic fluid 260.

Moreover, the electromagnetic force strengthens the integration of the electromagnetic fluid 231 that is provided on the outer surface of the magnet 230, thus increasing the performance of the electromagnetic fluid 231.

### Second Embodiment

FIG. 5 is a plan view of a vibrator 200 of a linear vibration motor, according to a second embodiment of the present invention. As shown in the drawing, a plurality of openings 413 is formed through a coupling part 412 of a yoke 410 to which a magnet 230 is coupled.

In the second embodiment, the openings 413 are formed by cutting off portions of a region of the coupling part 412 other than the junction between the magnet 230 and the yoke 410.

Furthermore, the four openings 413 having the same shape are formed through the coupling part 412.

In this embodiment, the coupling part 412 of the yoke 410 to which the magnet 230 is coupled covers the whole area of one side of the magnet 230. Thus, the coupling force between the magnet 230 and the yoke 410 is increased.

Therefore, the magnet 230 can be more reliably prevented from being removed from the yoke 210 when the vibrator 200 linearly vibrates.

As described above, in a linear vibration motor according to the present invention, magnetic flux leaks out through a plurality of openings which are formed through a coupling part of a yoke and have the same shape. Thus, noise, which is prevented when the linear vibration motor vibrates, can be reduced.

Furthermore, electromagnetic force which leaks out through the openings reacts to a plurality of magnetic fluids formed on an elastic member and thus strengthens integration of each magnetic fluid, thereby enhancing the performance of the magnetic fluids.

Although the embodiments of the present invention have been disclosed for illustrative purposes, it will be appreciated that the linear vibration motor according to the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A linear vibration motor, comprising:
a stator, comprising a coil forming a magnetic field using an external power applied thereto;
a vibrator, comprising a magnet facing the coil, and a yoke having a coupling part, with the magnet coupled to the coupling part, the coupling part having a plurality of openings therein so that an electromagnetic force generated by electromagnetic induction of the magnet and the coil leaks out through the openings; and
an elastic member having a first end coupled to the stator, and a second end coupled to the yoke, the elastic member elastically supporting linear vibration motion of the vibrator.

2. The linear vibration motor as set forth in claim 1, wherein the openings are formed through the coupling part by cutting off portions of a region of the coupling part, the region including a junction between the magnet and the yoke.

3. The linear vibration motor as set forth in claim 1, wherein the openings are formed through the coupling part by cutting off portions of a region of the coupling part other than a junction between the magnet and the yoke.

4. The linear vibration motor as set forth in claim 2, wherein the openings comprise four openings formed through the coupling part, the four openings having a same shape.

5. The linear vibration motor as set forth in claim 1, wherein the magnet is coupled to the coupling part of the yoke at a position facing the coil, the magnet being able to be inserted into the coil when the magnet linearly vibrates.

6. The linear vibration motor as set forth in claim 1, wherein the stator comprises
a bracket having an upper surface to which the coil is fastened;
a casing coupled to the upper surface of the bracket, the casing covering the bracket; and
a PCB (printed circuit board) provided between the bracket and the coil, the PCB applying electric currents to the coil.

7. The linear vibration motor as set forth in claim 6, wherein the stator further comprises:
a damper coupled to the bracket at a position facing the magnet.

8. The linear vibration motor as set forth in claim 1, wherein the vibrator comprises:
a weight coupled to an outer surface of the yoke;
a plate yoke coupled to a lower end of the magnet; and
a magnetic fluid provided on a circumferential outer surface of the magnet.

9. The linear vibration motor as set forth in claim 6, wherein the elastic member comprises a plurality of magnetic fluids provided on a surface thereof facing the casing.

10. The linear vibration motor as set forth in claim 3, wherein the openings comprise four openings formed through the coupling part, the four openings having a same shape.
